(19) United States
(12) Patent Application Publication
(10) Pub. No.: US 2026/0093763 A1
(43) Pub. Date: Apr. 2, 2026

(54) DEVICE LINKED TO INFORMATION MODULES OF A DECEASED

(71) Applicant: Darrell Scott Jones, Locust Grove, VA (US)

(72) Inventor: Darrell Scott Jones, Locust Grove, VA (US)

(21) Appl. No.: 19/342,554

(22) Filed: Sep. 27, 2025

Related U.S. Application Data
(60) Provisional application No. 63/699,875, filed on Sep. 27, 2024.

(51) Int. Cl. G06F 16/955; G06K 19/06

(52) U.S. Cl. CPC G06F 16/9554; G06F 16/9566; G06K 19/06121

(57) ABSTRACT

A device comprises a tag. The tag includes one or more codes. The one or more codes include a link to a web space. The web space includes one or more modules directed to information of a deceased. The one or more modules are selectable for purchase by one or more users.

### FIELD OF THE INVENTION

The present disclosure relates generally to a device linked to information modules of a deceased, and more particularly to a device, comprising a tag with a code that includes a link to a web space, which includes information modules of a deceased.

### BACKGROUND

During times of bereavement, the family of the deceased are acutely aware of the impact that the life of the deceased had on the people around them. The heritage that the deceased has left, may resonate with their family for years to come. However, it takes no more than a few years for those memories of that individual to diminish, and one generation for most of the amazing portions of the person's legacy to disappear completely.

### BRIEF OVERVIEW

The present disclosure is directed to a device comprising a tag. The tag includes one or more codes. The one or more codes include a link to a web space. The web space includes one or more modules directed to information of a deceased. The one or more modules are selectable for purchase by one or more users. The modules may include a biographical data module, gallery and slideshow module, places of interest module, related links module, discussion board module, guestbook module, family tree module, friends and acquaintances module, and/or custom pages module. The modules may be selectable by a user related to the deceased. The codes may include a QR code, data matrix, and/or bar code.

### BRIEF DESCRIPTION OF THE DRAWINGS

FIG. 1 illustrates gravestones with devices, according to one or more embodiments.

FIG. 2 illustrates a system that allows users to access a web space by scanning a QR code, according to one or more embodiments.

FIG. 3A illustrates a web space with multiple modules, according to one or more embodiments.

FIG. 3B illustrates a QR code and a QR code with a description, according to one or more embodiments.

FIG. 4A illustrates a biographical data module, according to one or more embodiments.

FIG. 4B illustrates a gallery and slideshow module, according to one or more embodiments.

FIG. 5A illustrates a places of interest module, according to one or more embodiments.

FIG. 5B illustrates a related links module, according to one or more embodiments.

FIG. 6A illustrates a guestbook module, according to one or more embodiments.

FIG. 6B illustrates a family tree module, according to one or more embodiments.

### DETAILED DESCRIPTION

Cemeteries are full of incredible stories (e.g., about the deceased), which can be unlocked through the use of a device (called a tribumark), comprising a tag, including a code, wherein the code includes a link to a dedicated web space, managed by the purchaser, which includes one or more modules directed to information relating to a deceased individual or pet. A tribumark can be affixed to any surface, such as a surface of a gravestone, memorial wall, grave, signage, historical building, roadside marker, tombstone, monument, bench, pet graves and/or pet memorials. The tribumark can be also applied to a garden-type stake, which can be pushed into the ground at the site of the individual or pet's grave.

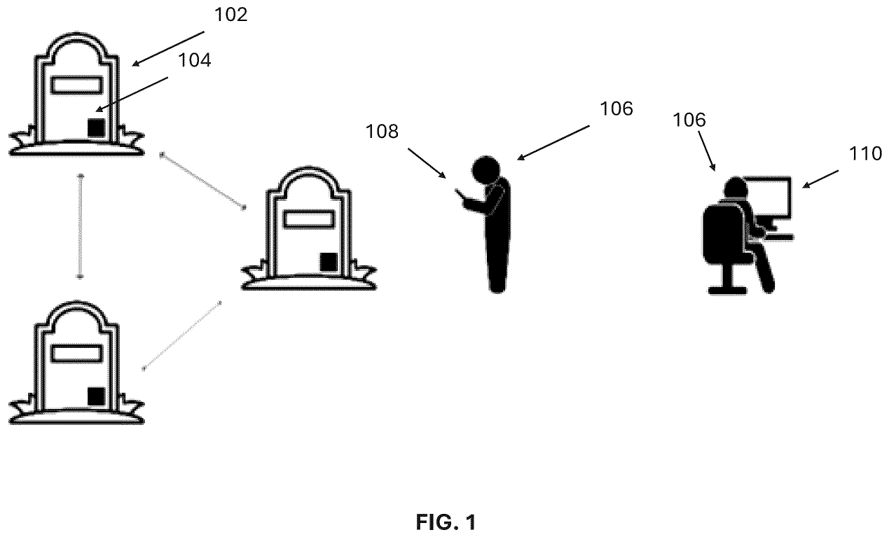

FIG. 1 illustrates devices (called tribumark) attached to gravestones, according to one or more embodiments. Each gravestone 102 may include a device 104. A user 106 can use a smartphone, or any other device equipped with a code reader, 108 to scan a code on the tag. By scanning the code, the user 106 can access a dedicated web space on a personal computer 110 or on a smartphone or any other internet-enabled device.

### Tribumark

A tribumark may include a tag. The tag may include weather-resistant brass, stainless steel or aluminum plate. The tag can also come in form of a flexible tape, such as an adhesive tape, which can be applied to curved surfaces. The tag can be applied to a surface through a simple peel and stick procedure. The tag can be applied to any surface, such as a headstone, grave marker, urn, memorial benches, pet graves, and/or plaques. The back of the tag may include glue, which is guaranteed to stick to any smooth surface and is applied by simply peeling off the plastic backing. The tag can be user-customized to show personalized text and/or graphical content which is added to the tag using a fiber laser engraving method. The tag may then be polished and/or coated with a weather-resistant clear coat finish. This ensures that a scanner is able to scan the tag for many years. The tag may be scanned using an internet-enabled device.

### Code

The tag may include a code, such as a data matrix, quick response (QR) code and/or any other 2D bar code. The code can be engraved (e.g., laser engraved) on the tag. The code may include personalized information, such as the person's name, year of birth, and/or year of death. A user can use a code reader to scan the code. The code reader may be part of a camera app on a smartphone or a dedicated code scanning app. The code reader uses a device's camera to capture the code, decoding the code. A URL (uniform resource locator) may be embedded in the code. A device's operating system may open the decoded URL in a web browser. A device's web browser may then render a public-facing web space to a user, provided at the unique URL. Upon purchase of a tribumark, the dedicated web space is created. The public web space may include the personal information of the deceased as well as a wealth of information concerning the family of the deceased. In addition, the private web space, accessed by a secure username and/or password combination, allows the purchaser the ability to manage the content that is shown to the viewer.

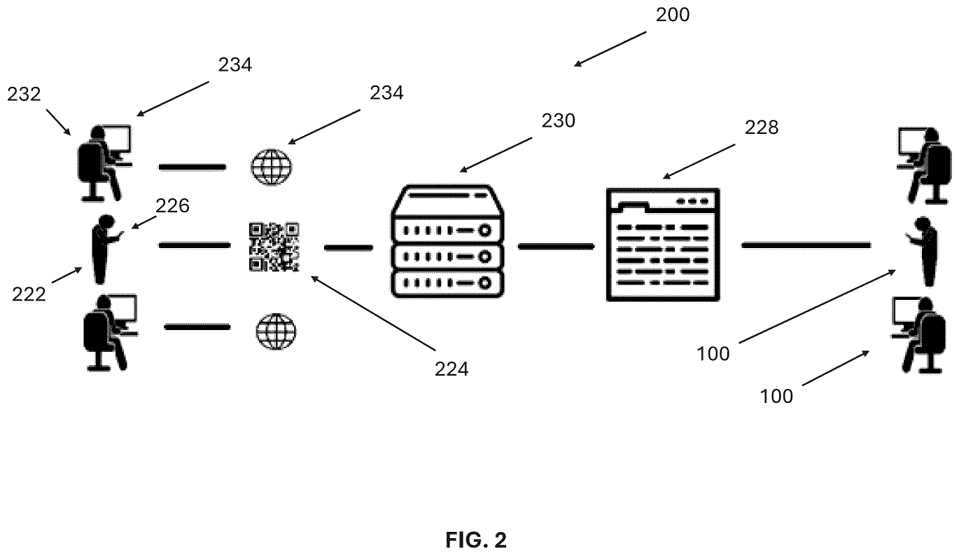

FIG. 2 illustrates a system that allows users to access a web space by scanning a QR code, according to one or more embodiments. The system 200 may include a QR code 224 that can be scanned by a user 222. The user 226 may use a smartphone or other code reading device to scan the QR code 224. Scanning the QR code opens a dedicated web space 228 on a web server 230. The web space 228 may include modules that can be managed by the user 222. The web space 228 may be also be opened by a user 232 on a personal computer 234. The personal computer 234 and/or the smartphone 226 may be connected to the server via the world wide web 234.

### Web Space

The data embedded in the code may include a link to a public-facing web space. The link may include a unique URL of the public-facing web space. The unique URL can also be accessed using internet search tools, such as search functionality available on the tribumark public web site, or any internet search engine. When the tag is scanned, a web space, dedicated to the deceased and/or the family of the deceased, may open. The web space may commemorate the life of the deceased as well as the relationships and legacy of the family. The personalized web space may represent the family of the deceased, allowing the user to navigate through the family tree to any individual that has a tribute (profile). Each tribute can include a family tree, personal biographical information, obituaries, photo galleries, videos, related links, guestbook, discussion board. Any passerby can access the dedicated web space via the code or by using a web browser to access the URL.

### Modules

The dedicated web space may include a collection of modules, which can be completed by the purchaser or another authorized user. A tribumark may include a document with a list of the modules that may be available on the public-facing web space. These modules may be managed by the purchaser and may be turned on/off as needed by the purchaser. The purchaser can assign permissions to other users to manage the various modules. The public-facing web space may continue to function with a subset of the modules. Below is a list of the available modules and their functions. An administrator may turn any of the modules on or off. An administrator can invite other people to manage a dedicated web space. Permissions can be assigned to any user to manage any combination of modules. Invitations may be sent via email, which may include a unique link that enables the user to begin managing the module(s).

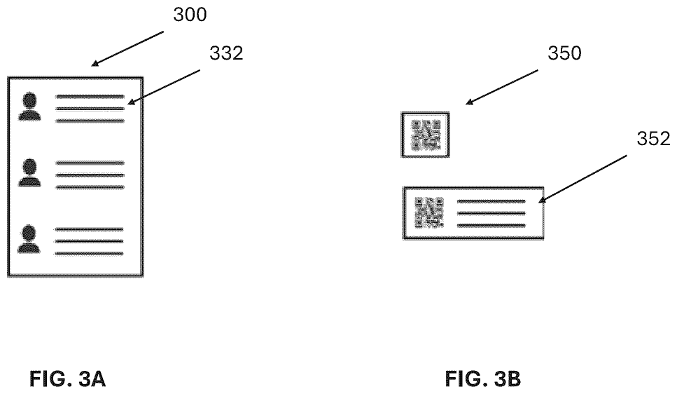

FIG. 3A illustrates a web space 300 with multiple modules 332, according to one or more embodiments.

FIG. 3B illustrates a QR code 350 and a QR code with a description 352, according to one or more embodiments.

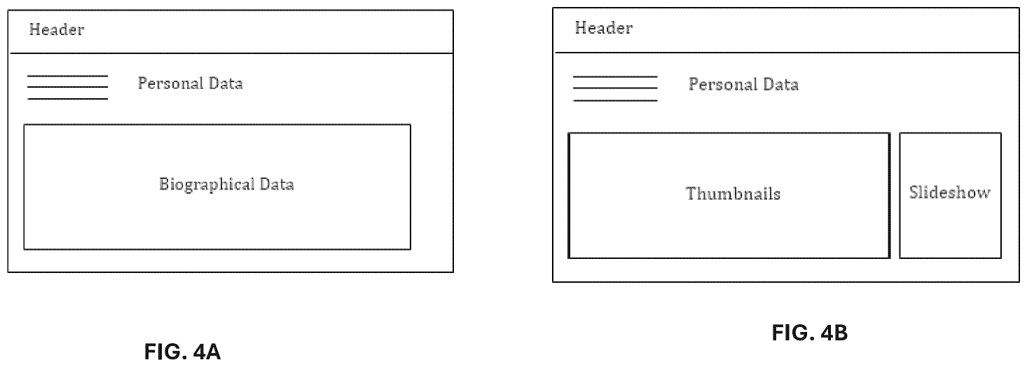

FIG. 4A illustrates a biographical data module, according to one or more embodiments. A biographical data module may include basic personal information concerning the deceased and the family of the deceased. This information may include names, birth date, date of death, gender, and a description of the life of the deceased and his/her impact and legacy. Images can also be uploaded to the gallery and used in the biographical data. An unlimited amount of text can be used in describing the life and legacy of the deceased. In addition, an obituary can optionally be added to the biographical data module. If the purchaser is attempting to commemorate the lives of two people, such as in the case of a dual headstone, the purchaser may opt to include more than one biographical data module so each individual may have their own biographical data.

The biographical data module may include basic personal information of the deceased including names, birth date, date of death, gender and/or a long description of the life and accomplishments of the deceased. The biographical data module may include basic personal information, bio, and/or obituary. The basic personal information may include name(s), birth date, date of death, and/or gender. The bio may include an unlimited long text description of the life of the deceased, where images from the gallery can be added to the long text description.

A purchaser, and/or authorized user, can manage the biographical data module. A biographical data module may include a rich text box, which allows basic formatting of data entered, including uploading of images from the gallery, and/or HTML formatting in a WYSIWYG (What You See Is What You Get) environment.

FIG. 4B illustrates a gallery and slideshow module, according to one or more embodiments. The gallery may be a collection of images, to which a user with appropriate permissions can upload up to 100 images or videos relating to the deceased. The purchaser can add and delete pictures as well as manage the ordering of the uploaded files. In the gallery, the user is also able to mark certain uploaded pictures so that they can appear in a slideshow. The slideshow can have up to 100 pictures with captions. A music selection may be available, which may play in a loop while the slideshow is in progress. Images included in the gallery can be used in other modules, such as the biographical data module and/or the related links module. A purchaser, and/or authorized user, can manage a list of images, which can be used throughout the modules. Some images can be enabled to be used in a slideshow presentation. The gallery can include up to 100 uploaded images.

The gallery and slideshow module allows the Administrator(s) to upload images to the gallery. The images may be automatically sized appropriately for use on the website. The images may be stored on the website. This module may include a list of thumbnail images that the user can select and view in a larger format. Additionally, certain images can be marked to appear in a slideshow. The Administrator(s) can determine the order of these images and apply a text description to the image. A music selection can also be selected to play while the slideshow is playing. The images can be used throughout some of the other modules as well. The gallery and slideshow module may include a list of thumbnails showing all of the available images, the ability to mark each image to appear or not appear in the slideshow, the ability to select music to play while the slideshow is playing, and/or text to appear with each image shown during the slideshow.

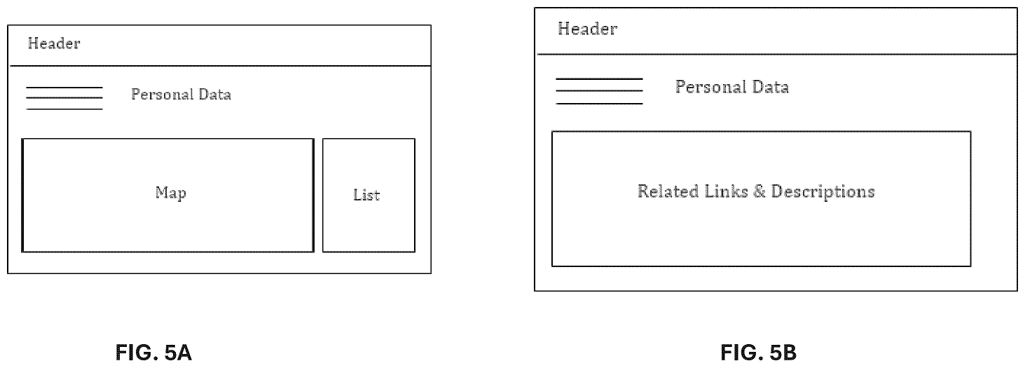

FIG. 5A illustrates a places of interest module, according to one or more embodiments. The places of interest module allows the purchaser, and any user with appropriate permissions, to manage the places of interest. The places of interest may be points on a map, which hold special meaning to the deceased or the family of the deceased and may include the location of the deceased final resting place. A purchaser may pick the places from points on a map or enter the places. The places of interest may then be available for viewing via a map on the deceased person's profile and/or as a list. The map may be filterable by place type. For instance, a viewer may filter the map, so that places where the deceased or the persons in the deceased individual's family tree have lived, may be shown.

The places of interest module allows the purchaser(s) to select places on a map, or enter them manually, which were of particular relevance to the deceased. Locations can include place of birth, place of death, churches, places of employment, schools, and/or places the deceased lived. Upon opening the places of interest module, a viewer may be shown a map of places of interest along with a list of places and/or a text description. A places of interest module may include a list of places of interest, a map, which graphically shows places of interest, where the map and the list are filterable by place type. A purchaser, and/or authorized user, can manage a places of interest module. A place of interest can be added by selecting a location on a map, and/or by entering a location manually with a valid address. This allows the viewer to see places that are of particular interest to the deceased and/or the family of the deceased.

FIG. 5B illustrates a related links module, according to one or more embodiments. The related links module allows the user to enter multiple links to external web sites which have content related to the deceased or the deceased individual's family, or links to web spaces which have relevance to the deceased. This can include businesses, schools, military units, etc. The user can add the link and text which describes the content of the link. A purchaser, or authorized user, can manage a related links module. A related links module may include links to external websites. In addition to a link to external websites, text and pictures can be uploaded. A related links module may include links to external web sites that are of relevance to the deceased or the deceased's family. For example, a video uploaded to another platform that details the life of the deceased, and/or a web site representing a company that the deceased was associated with. A related links module may include a list of related links with text descriptions. The Related Links module also allows the purchaser, or other authorized user, to link the web space to another web space of an individual or pet that was related or had special significance to the deceased.

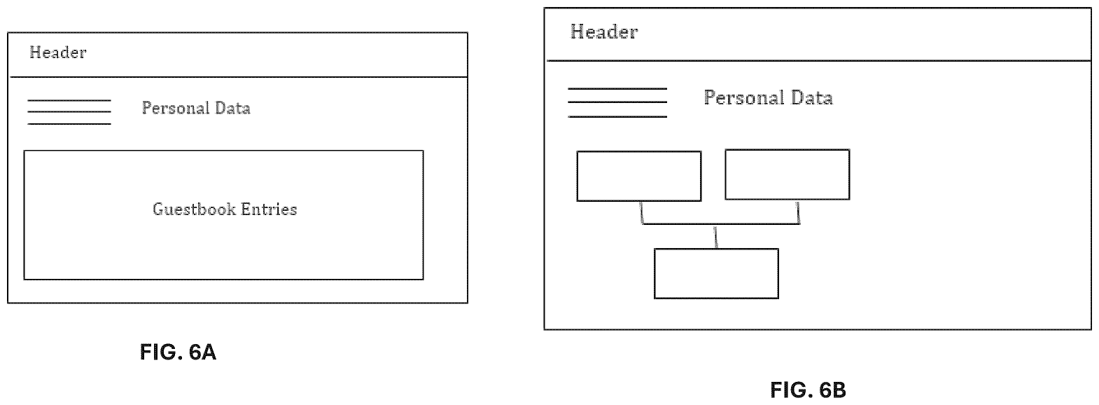

FIG. 6A illustrates a guestbook module, according to one or more embodiments. A guestbook module allows viewers to sign a guestbook and leave a comment. Any person viewing the dedicated web space can sign the guestbook. Purchasers, or other authorized users, have a right to remove any entry to the guestbook so that it cannot be viewed publicly. A guestbook module allows any visitors to the public web space to log that visit and, optionally, add text concerning the deceased. The purchaser, or other authorized user, has the ability to hide comments which they do not want to show on the site. The guestbook module may include a list of comments added by the visitor and/or a total number of visits. A purchaser, and/or authorized user, can manage the guestbook. Any unwanted guestbook entries can be removed from public view.

FIG. 6B illustrates a family tree module, according to one or more embodiments. A family tree module allows an administrator to enter and maintain a complete family tree. The family tree may show the relationships between individuals related to the deceased. A viewer can navigate through the family tree by clicking on the individual family members who have tribumarks associated with them. Family members can continue to navigate through other family trees as they are presented to them. A page of a family tree module may include basic information about family members, such as name, place of birth, place of death, and/or date of death. A family tree module may include a graphical list of people included on the family tree of the deceased. A family tree may be presented in a tree format. A viewer can navigate through the family tree by clicking on any of the members which have purchased a tribumark. A family tree module allows creation and maintenance of a complete family tree. A family tree module shows relationships between family members. Viewers can navigate through the family tree by clicking on individuals. An administrator, and/or authorized user, can manage the family tree. A family tree may be a graphical representation of the family of the deceased. New family members can be added or removed from the family tree. If any family member has a tribumark profile, the viewer can navigate directly to that family member's profile.

Further modules included in the web space are:

### Discussion Board Module

The discussion board module allows viewers, authorized to participate in discussions, to post to a discussion board. A discussion board allows family and/or friends of the deceased to recall and discuss the deceased and an impact on their lives. Viewers can reply to existing discussion threads and/or create new ones. Viewers can only delete posts which they have created. An administrator, and/or authorized user, can manage the posts entered via the discussion board. Only authorized users can post to the discussion board. But, any viewer can see a read-only version of the data.

### Friends and Acquaintances Module

A friends and acquaintances module allows the administrator to show links to other tribumark profiles. For example, a deceased individual who was part of a military unit, could be treated like all the other members of that unit, so that viewers can navigate through those profiles and related family trees. A short text description can be added to each link to help identify that individual. The administrator, or authorized user, can manage the friends and acquaintances module. This is a list of people known to the deceased, and/or the family of the deceased, who have active tribumark profiles. A link may enable the viewer to navigate to other tribumark profiles using the friends and acquaintances module.

### Custom Pages Module

Administrator(s) can create custom pages that represent particular topics in the life of the deceased or the family of the deceased. These custom pages may be linked into the navigation of the public web space. An administrator can create custom pages, which can include any text and/or images needed. Custom pages may be a place to store any data that doesn't fit within other modules. Upon purchase of a tribumark, a purchaser sets up a username and/or password combination, which allows access to the administrative panel (admin panel). From an admin panel, an administrator can manage all data included in personal web spaces. An administrator, and/or authorized user, can create additional pages which may appear in the navigation of the dedicated web space. Additional pages can include text and/or images at the administrator's discretion. Administrator(s) may be given a private web space protected by encrypted usernames and passwords. This private web space may include tools to manage all the content present in each of the modules listed above.

What is claimed is:

1. A device, comprising a tag, including one or more codes, wherein:
the one or more codes include a link to a web space,
the web space includes one or more modules directed to information of a deceased, and
the one or more modules are selectable for purchase by one or more users.

2. The device of claim 1, wherein the one or more modules are purchasable.

3. The device of claim 1, wherein the one or more modules include a biographical data module, gallery and slideshow module, places of interest module, related links module, discussion board module, guestbook module, family tree module, friends and acquaintances module, and/or custom pages module.

4. The device of claim 1, wherein the user is related to the deceased.

5. The device of claim 1, wherein the one or more codes include a QR code, data matrix, and/or bar code.

6. The device of claim 1, wherein the code includes a uniform resource locator to the web space.

7. The device of claim 1, wherein the code is laser engraved on the tag.

8. The device of claim 1, wherein the tag includes weather-resistant brass, stainless steel or aluminum plate.

9. The device of claim 1, wherein the tag includes flexible tape and/or adhesive tape.
